(19) United States
(12) Patent Application Publication
(10) Pub. No.: US 2004/0199824 A1
(43) Pub. Date: Oct. 7, 2004

(54) Device for safety-critical applications and secure electronic architecture

(76) Inventor: Werner Harter, Illingen (DE)

Correspondence Address: KENYON & KENYON, ONE BROADWAY, NEW YORK, NY, 10004, US

(21) Appl. No.: 10/763,903

(22) Filed: Jan. 23, 2004

(30) Foreign Application Priority Data
Jan. 23, 2003 (DE) 103 02 456.5

(51) Int. Cl. H02H 3/05

(52) U.S. Cl. 714/30

(57) ABSTRACT

A computer device for controlling applications critical with regard to safety is provided, which computer device has at least one processor unit and at least one self-test unit assigned to the processor unit, a memory unit for storing programs and process data, a memory management unit for controlling memory accesses in the computer device, an error detection unit for detecting errors in the memory unit, and connection means for connecting the processor units to one another and to the memory management unit. The processor units are positioned together with the memory unit on a shared chip surface area.

### FIELD OF THE INVENTION

The present invention relates to a secure electronic architecture, and relates in particular to a computer device for controlling applications critical with regard to safety, in which a memory unit and at least one processor unit work together efficiently.

### BACKGROUND INFORMATION

Distributed systems which are relevant with regard to safety are used, for example, in the automotive field and/or in automotive engineering as X-by-wire systems, and the functional safety of systems of this type is to be ensured. A known control unit for controlling applications critical with regard to safety is described in German Published Patent Document No. DE 199 02 031. Methods having self-testing, plausibility monitoring, and a watchdog are known for single-computer control units.

In German Published Patent Document No. DE 199 02 031, a monitoring unit has first means for measuring the closed-circuit current of a microcomputer and a second means to apply a test data signal to the microcomputer to process the test data signal and to compare a test data output signal of the microcomputer with a corresponding test data output signal of the monitoring unit.

A further known microprocessor system for controlling applications critical with regard to safety is described in German Published Patent Document No. DE 195 29 434, in which supplied data are processed redundantly by connecting CPUs via separate bus systems to the read-only memory and to the random access memory, as well as to input and output units, and by connecting the separate bus systems to one another via driver stages.

Complete computer units typically include storage units for storing process data, processor units for processing process data, and a memory management unit for controlling memory accesses. Furthermore, error detection units are used to detect errors in memory units and then possibly correct them with the aid of error correction units. In general, each memory unit is assigned an error detection unit and/or an error correction unit. Generally, a self-test unit, which is assigned to a corresponding processor unit, is provided for checking processor units which interact with the memory units. The memory unit is typically situated on a chip surface, i.e., a chip that has an assigned processor unit. In this case, the memory unit requires significantly more surface area than the processor unit, i.e., most of the chip surface area on which a memory unit and a processor unit are situated will be taken up by the memory unit. For example, the ratio of the surface area of the memory unit to the surface area of the processor unit may be 30:1.

Furthermore, the probability of occurrence of errors on the chip is proportional to the surface area of the chip, which means that the error probability with regard to the memory unit is significantly greater than the error probability with regard to the processor.

A computer system which uses a dual core is described in German Published Patent Document No. DE 195 29 434. This system has a “fail-silent” behavior, i.e., the system has a defined behavior, which is not harmful to the functionality of the remaining circuit components, if an error is recognized.

A disadvantage of the dual core concept is that it is sensitive to common-mode errors, i.e., interference through short-term spikes on the supply voltage or electromagnetic interference influences both (computer) cores in the same way, so that errors which are supplied to a comparison unit cannot be recognized.

Therefore, an unrecognized error may cause an effect which will not be recognized in the application. Even if the “lock-step concept” is used, common-mode errors are possible if interference lasts longer than the duration of a delay time between the two cores. In contrast, the duration of the delay time is limited to the time of a command execution, since in the event of a longer duration the two cores may irreversibly lose their synchronization. For example, an external interrupt signal may be provided for the duration of a command execution, which causes the non-delayed core to execute an interrupt program, while the core operating with a delay executes its normal program because an interrupt signal is no longer applied.

A further disadvantage of the dual core concept is that errors are not detected until the corresponding resources are needed, e.g., when a specific section of the program is executed or when a part of the core is needed, when an instantaneous difference between the results of the two cores then occurs.

An object of the present invention is to provide a computer device in which the chip surface areas are better used with regard to the errors occurring in the memory and processor units situated on these chips, and in which a memory-processor system is optimized.

### SUMMARY

An example embodiment of the present invention positions memory units together with error detection units and/or error correction units and, simultaneously, positions processor units together with assigned self-test units on a shared chip; a combination of a memory unit and error detection unit and/or error correction unit is assigned more than one combination of a processor unit (also referred to as a processor system) and an assigned self-test unit.

The computer device according to an example embodiment of the present invention has the advantage that a combination of a self-monitoring (self-test) computer core having the BIST (built in self test) concept and a fail-safe memory unit is provided. The single-core BIST concept avoids the disadvantages of a dual-core concept, since through a combination of a memory unit, which has an assigned error detection unit and/or an assigned error correction unit, with a processor unit, which has a self-test unit assigned, error tolerance levels are achieved which are “fail-silent” for the core, “fail-silent” for the memory unit having an assigned error detection unit, “fail-operational” for the memory unit having an assigned error correction unit in regard to the first error, and “fail-silent” in regard to the second error.

This means that the core may discover an error and then switch itself passively to a defined behavior which is harmless to the remaining circuit units. The memory having an error detection unit has the same behavior, while the memory having an error correction unit operates further without restrictions for the occurrence of first error, and has a defined, harmless behavior for the occurrence of second error.

The computer device according to an example embodiment of the present invention for controlling applications critical with regard to safety includes, for example:

a) at least one processor unit;

b) a memory unit for storing process data;

c) a memory management unit for controlling memory accesses in the computer device;

d) an error detection unit for detecting errors in the memory unit;

e) at least one self-test unit assigned to the processor unit; and

connection means for connecting the processor units to one another and to the memory management unit, the processor units being positioned together with the memory unit on a shared chip surface area.

According to an example embodiment of the present invention, the error detection unit may be implemented as an error correction unit, so that correction of errors may advantageously be provided in the memory unit.

According to an example embodiment of the present invention, each processor unit is assigned a self-test unit for performing a self-test.

According to an example embodiment of the present invention, the computer device has two processor units coupled by connection means, each of which is assigned a self-test unit.

According to an example embodiment of the present invention, a combination of computer devices, which have an identical or different number of processor units, is provided using at least one connection unit. In this case, the connection unit is expediently designed in such a way that an appropriate number of bits may be transmitted over the connection unit.

According to an example embodiment of the present invention, each memory unit of the computer device is assigned its own error correction unit.

According to an example embodiment of the present invention, the memory management unit for controlling memory accesses in the computer device and the at least one processor unit are implemented integrally as one single unit.

Furthermore, the method according to an example embodiment of the present invention for processing process data in a computer device for applications critical with regard to safety includes, for example, the following steps:

a) processing process data in at least one processor unit;

a1) the at least one processor unit being tested using at least one self-test unit assigned to the processor unit;

a2) the processor units being connected to one another and to the memory management unit using connection means in the computer device, the processor units being positioned together with the memory unit on a shared chip surface area;

b) controlling memory accesses in the computer device using a memory management unit;

c) storing process data in a memory unit; and

d) detecting errors in the memory unit (102) using an error detection unit.

According to an example embodiment of the present invention, errors in the memory unit are corrected using an error correction unit.

According to an example embodiment of the present invention, two processor units coupled by connection means are each tested by assigned self-test units in the computer device.

According to an example embodiment of the present invention, computer devices which have an equal or different number of processor units are combined using at least one connection unit.

According to an exemplary embodiment of the present invention, the memory unit in each computer device is checked and corrected for errors using an assigned error correction unit.

According to an example embodiment of the present invention, the at least one processor unit is tested using an assigned self-test unit.

According to an example embodiment of the present invention, the self-test unit outputs an error message to an external display unit and/or an error processing unit via self-test unit output means if a processor unit is recognized to be faulty by the assigned self-test unit.

According to an example embodiment of the present invention, the processor units exchange starting values, intermediate results or intermediate values, and final results amongst the processor units via the connection means, and the processor units check these values for uniformity.

According to an example embodiment of the present invention, the processor unit outputs an error message to an external display unit and/or an error processing unit via processor unit output means if the processor unit determines a deviation between the intermediate results or intermediate values and/or final results.

According to an example embodiment of the present invention, if errors occur in the memory unit, an error message is output via error detection unit output means to an external display unit and/or an error processing unit.

According to an example embodiment of the present invention, if errors occur in the memory unit, an error message is transmitted via the memory management unit to the processor unit, by which the error message is subsequently output via the processor unit output means to an external display unit and/or an error processing unit.

### BRIEF DESCRIPTION OF THE DRAWINGS

FIG. 1 shows a computer device having a memory unit with an assigned error detection unit and a single processor unit with an assigned self-test unit.

FIG. 2 shows the computer device of FIG. 1 with the error detection unit being replaced by an error correction unit.

FIG. 3 shows a computer device having two processor units.

FIG. 4 shows a computer device having two processor units in combination with a further computer device having one processor unit.

FIG. 5 shows the combination of two computer devices, each of which has two processor units as shown in FIG. 3.

### DETAILED DESCRIPTION

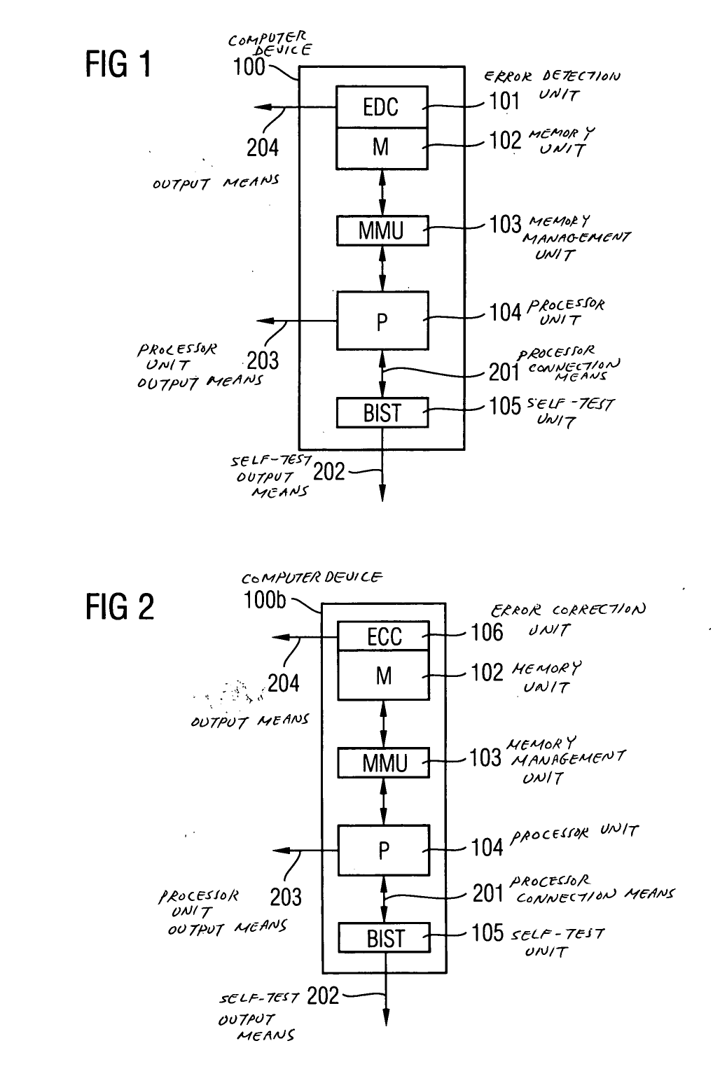

In computer device 100 shown in FIG. 1, which may be positioned on one single chip surface area, a memory management unit (MMU) 103 controls memory accesses in computer device 100, memory management unit 103 interacting with processor unit 104 and with memory unit 102. According to the present invention, memory unit 102 is assigned an error detection unit 101, which detects errors in memory unit 102.

Because of the larger chip surface area claimed by memory unit 102, a higher error tolerance level may be necessary for memory unit 102 than for the computer core, i.e., processor unit 104. The chip surface area occupied by the memory unit may be larger by an order of magnitude than the chip surface area occupied by the processor unit. In a simplified view, error probability is proportional to the occupied chip surface area. Processor unit 104 is monitored by a self-test unit 105, which is assigned to processor unit 104 and connected thereto via processor connection means 201, 201a, 201b, and/or a self-test of processor unit 104 is performed by self-test unit 105.

Through the single-core concept which is schematically illustrated in FIG. 1, the disadvantages of the dual-core concept previously described above may be avoided. In this case, the computer core is implemented “fail-silent,” i.e., in the event of an error, the entire system of the computer core enters into a defined state which is harmless to the remaining circuit components.

Memory unit 102, which is provided with a higher error tolerance level, is implemented as either “fail-silent” or “fail-operational”. In FIG. 1, a memory unit is shown which is implemented as “fail-silent” using error detection unit 101. A “fail-silent” microcomputer may thus be implemented optimally in regard to both chip surface area and costs.

FIG. 2 differs from FIG. 1 in that memory unit 102 is designed as “fail-operational,” i.e., error detection unit 101 is replaced by an error correction unit 106.

It is to be noted that memory unit 102 may include both a ROM (read-only memory) and a RAM (random access memory).

Using a flash-ROM, information of memory cells of memory unit 102 may be reprogrammed even in operation, through which a possibility for correcting memory unit 102 is provided. Therefore, in a computer device 100b as shown in FIG. 2, which contains a flash-ROM as a memory unit 102 together with an error correction unit 106, not only may processor unit 104 correct the data received from the memory unit before processing, but the processor unit may also additionally reprogram the memory unit with the corrected data value. Significant advantages thus result in regard to simplification of a secure electronic architecture, i.e., a computer architecture of control units:

(i) applications having a “fail-silent” requirement in regard to a microcomputer are based on a single-error tolerant memory having a “fail-silent” processor unit;

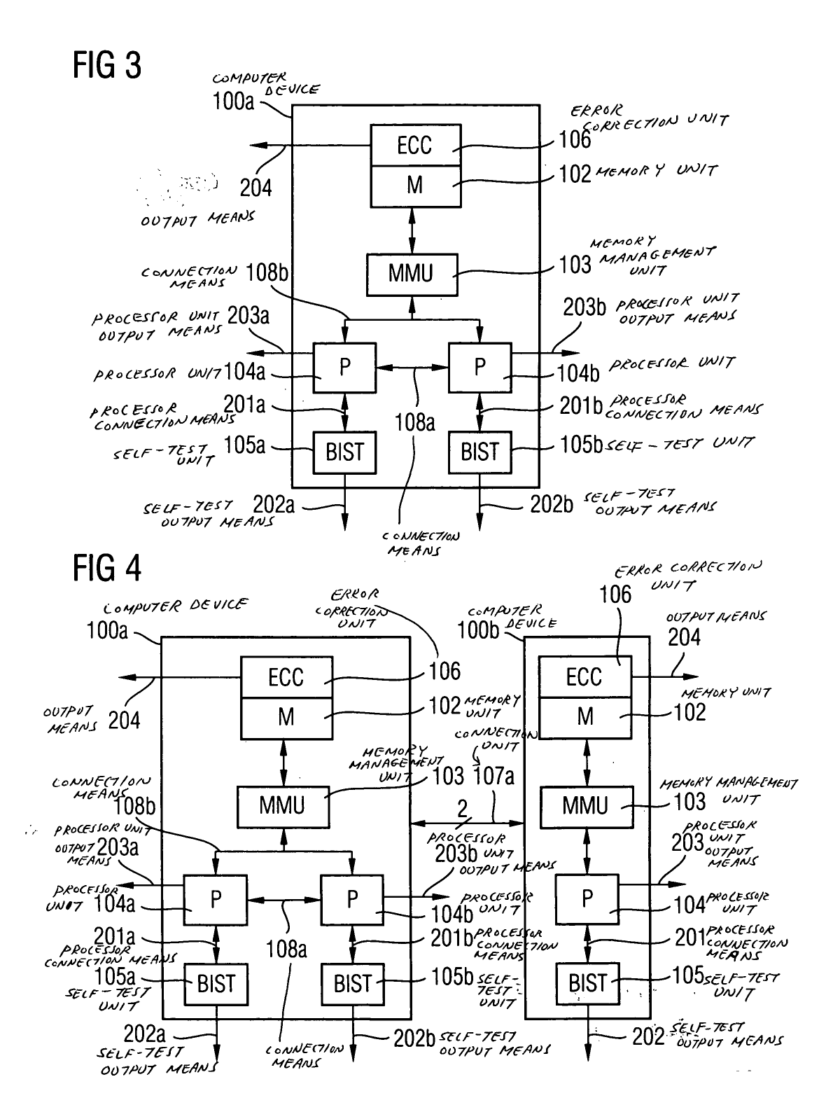

(ii) applications having a requirement for single-error tolerance in regard to the microcomputer use two secure processor units, which, depending on the further requirements in regard to error tolerance of the voltage supply and error tolerance in regard to common-mode errors, may be housed in one or two control units, as will be described below with reference to FIG. 3;

(iii) applications having a requirement for single-error tolerance in regard to the microcomputer are based on three secure processor units, which, depending on the further requirements in regard to error tolerance of the supply voltage and error tolerance in regard to common-mode errors, may include one, two, or three control units; and

(iv) further combinations of a “fail-operational” module and a secure microcomputer are provided.

The computer devices shown in FIGS. 1 and 2 may each be doubled for two different supply voltages, so that by doubling computer device 100b shown in FIG. 2, a two-channel system made of two computer devices results, which is single-error tolerant in regard to memory errors and also single-error tolerant in regard to processor errors. By using two supply voltages, the system is also single-error tolerant to errors of the supply voltages. Furthermore, by doubling computer device 100b from FIG. 2, a two-channel system made of two computer devices results, which is double-error tolerant in regard to memory errors and single-error tolerant in regard to processor errors. By using two supply voltages, the system is again single-error tolerant to errors of the supply voltages.

It is to be noted that a single-error tolerant memory or a single-error tolerant processor system is understood to be a memory or processor system which is error tolerant to the occurrence of one error, and a double-error tolerant memory or a double-error tolerant processor system is understood to be a memory or processor system which is error tolerant to the occurrence of two errors.

Thus, it is possible as shown in FIG. 2 that the entire system operates further if one error occurs in memory unit 102 (single-error tolerant memory), while if one error occurred in processor unit 104, the processing would be interrupted and the system would enter a defined state, and/or have a defined behavior which is harmless to the remaining circuit components (“fail-silent” processor).

FIG. 3 shows a computer device 100a which, besides a single-error tolerant memory (memory unit 102) also provides a single-error tolerant processor system. For this purpose, two independent processor units 104a and 104b are provided in computer device 100 shown in FIG. 3, which are connected to one another by a first connection means 108a to exchange process data information. Furthermore, both processor units 104a, 104b are connected to memory management unit 103 using a second connection means 108b.

As described above with reference to FIGS. 1 and 2, each processor unit is also assigned a corresponding self-test unit 105a and 105b, which perform self tests in regard to particular processor unit 104a, 104b in the way described. In this way, the computer device according to an example embodiment of the present invention may couple a single-error tolerant memory to a single-error tolerant processor system.

Therefore, an error may arise in one of the processor units 104a, 104b without processing operation having to be interrupted in entire computer device 100a.

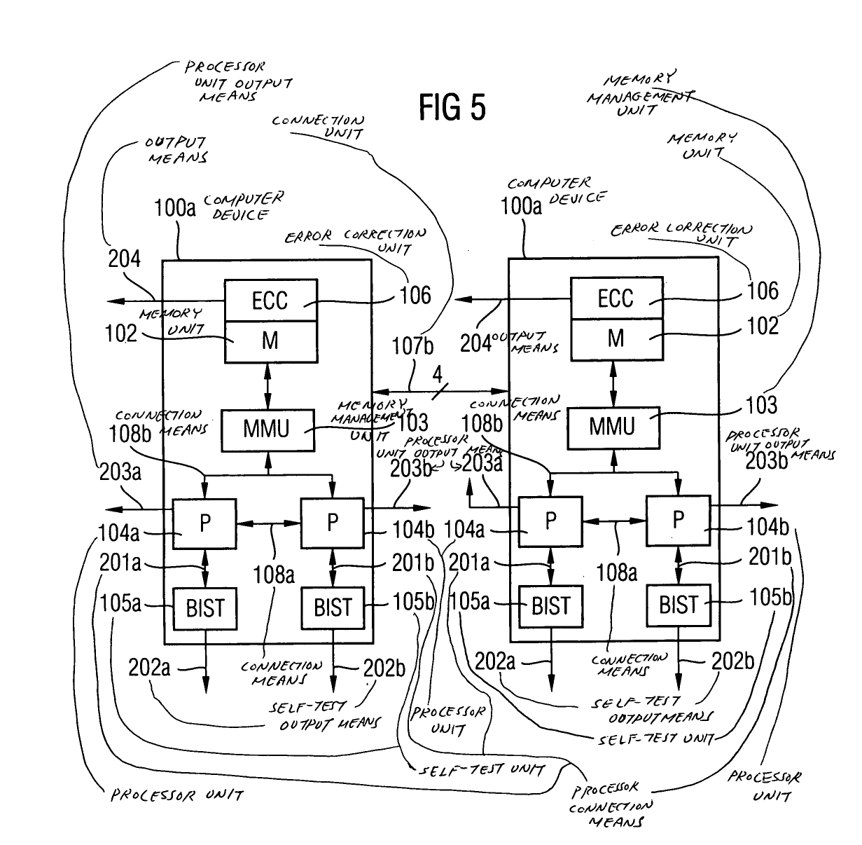

FIGS. 4 and 5 show examples of further embodiments of the device according to the present invention and the method according to the present invention for processing process data in a computer device for applications critical with regard to safety.

In FIG. 4, a computer device 100a, which corresponds to the computer device described with reference to FIG. 3, is combined with a computer device 100b, which corresponds to the computer device described with reference to FIG. 2. Computer devices 100a and 100b are connected to one another by a connection unit 107a, which is designed in such a way that a number of connection lines corresponding to the desired error tolerance level is provided. In this case, two bidirectional connection lines are provided, so that the connection unit is implemented as error-tolerant for one error. After the breakdown of one connection line, the connection is still operational via the second connection line.

The combination according to the example embodiment of the present invention shown in FIG. 4 results in an arrangement having three computer cores, through which the overall system includes a single-error tolerant memory and a single-error tolerant processor system at two supply voltages. It is to be noted that in this case the supply voltage must also be designed using two channels. Furthermore, it is possible for more than two computer cores and/or processor units 104a, 104b to be positioned in a computer device 100a, although it is not shown in the figure. Through the modular construction shown in FIGS. 4 and 5, application-specific requirements for error tolerance in regard to the memory units and/or the processor units may be fulfilled easily.

FIG. 5 shows a further exemplary embodiment according to the present invention, two computer devices 100a being connected in this case via connection unit 107b, which has an appropriate number of connections (here: 4), selected in accordance with the desired error tolerance for errors on the connection lines. If the four connection lines are implemented as bi-directional, a tolerance to three faulty connection lines results.

Both computer devices 100a of the exemplary embodiment shown in FIG. 5 correspond to computer device 100a described with reference to FIG. 3. Through the configuration shown in FIG. 5, a symmetric system is formed including two computer devices 100a which are connected to two supply voltages and contain a single-error tolerant memory unit 102 and a single-error tolerant processor system each. The overall system shown in FIG. 5 is then double-error tolerant to memory errors in memory unit 102 and 3-error tolerant to errors in processor units 104a, 104b.

It is to be noted that in this case the supply voltage must also be designed using two channels.

Using the arrangement according to the present invention and the method according to the the present invention, it is possible for self-test unit 105, 105a, 105b to output an error message via self-test output means 202, 202a, 202b to an external display unit and/or an error processing unit if a processor unit 104, 104a, 104b is recognized as faulty by assigned self-test unit 105, 105a, 105b. Furthermore, it is expedient that processor units 104, 104a, 104b exchange starting values, intermediate values or intermediate results, and final results amongst the processor units 104, 104a, 104b via connection means 108a, 108b and check the values for uniformity.

It is ensured that processor unit 104, 104a, 104b outputs an error message via processor unit output means 203, 203a, 203b to an external display unit and/or an error processing unit if processor unit 104, 104a, 104b detects a deviation between the intermediate results and/or final results. In addition, it is possible that in the event of errors in memory unit 102, an error message is output via error detection unit output means 204 to an external display unit and/or an error processing unit. In addition, it is also ensured that in the event of errors in memory unit 102, an error message is transmitted via memory management unit 103 to processor unit 104, 104a, 104b, from which the error message is subsequently output via processor unit output means 203, 203a, 203b to an external display unit and/or an error processing unit.

The computer device according to the present invention may also be designed in such a way that, instead of self-test units 105, 105a, 105b positioned in respective processor units 104, 104a, 104b, further processor modules are provided which execute the self-tests in regard to particular processor unit 104, 104a, 104b.

An advantage thus results that besides a self-test of the processor units, a comparison of starting values, intermediate values or intermediate results, and final results is possible via connection means 108a and/or 108b.

Further advantages result from the combination of the self-test method of a processor unit and self-test unit with the dual-processor made up of two processor units:

(i) through cyclically executed self-tests, “sleeping” errors in parts of the processor units not used by the process-data processing may be discovered, so that faulty processor units may be shut down before the errors are made noticeable by a value comparison between the processors;

(ii) the additional continuously executed exchanges and comparisons of values between the processor units determine all acute errors which have an effect in a value difference;

(iii) after an occurrence of an error discovered by the value comparison between two processors, the defective processor unit is identified and shut down by the subsequent cyclic self-test, so that the functional processor unit may operate further; in this manner, the availability of the computer device is increased, since it does not have to be shut down in the event of every acute error.

Although the present invention was described above on the basis of exemplary embodiments, it is not restricted thereto, but is modifiable in several ways.

The present invention is also not restricted to the possible applications cited.

What is claimed is:

1. A system having at least one computer device for applications critical with regard to safety, comprising:
at least one processor unit;
a memory unit for storing process data;
a memory management unit for controlling memory accesses in the computer device;
an error detection unit for detecting errors in the memory unit;
at least one self-test unit assigned to the processor unit; and
connection means for connecting the at least processor unit to at least one of another processor unit and the memory management unit, the at least one processor unit being positioned together with the memory unit on a shared chip surface area.

2. The system as recited in claim 1, wherein the error detection unit is implemented as an error correction unit for correcting errors in the memory unit.

3. The system as recited in claim 1, wherein each processor unit is assigned a self-test unit for performing a self-test.

4. The system as recited in claim 1, wherein two processor units are coupled by the connection means, each processor unit being assigned a self-test unit.

5. The system as recited in claim 1, wherein a plurality of computer devices are connected to one another with the aid of at least one connection unit, the plurality of the computer devices having one of an equal and different number of processor units.

6. The system as recited in claim 1, wherein each memory unit is assigned one error correction unit in the computer device.

7. The system as recited in claim 1, wherein the memory management unit for controlling the memory access in the computer device and the at least one processor unit are implemented integrally as a single unit.

8. A method for process-data processing in at least one computer device having at least one processor unit for applications critical with regard to safety, comprising:
testing the at least one processor unit using at least one self-test unit assigned to the processor unit;
positioning the at least one processor unit together with a memory unit on a shared chip surface area;
connecting the at least one processor unit to at least one of another processor unit and a memory management unit using connection means in the at least one computer device;
controlling memory accesses in the at least one computer device using the memory management unit;
storing process data in the memory unit; and
detecting errors in the memory unit using an error detection unit.

9. The method as recited in claim 8, wherein errors in the memory unit are corrected using an error correction unit.

10. The method as recited in claim 8, wherein two processor units, coupled by the connection means, are each tested by assigned self-test units in the at least one computer device.

11. The method as recited in claim 8, wherein at least two computer devices having one of an equal and different number of processor units are combined using at least one connection unit.

12. The method as recited in claim 8, wherein the memory unit in the at least one computer device is checked for errors and corrected using an assigned error correction unit.

13. The method as recited in claim 8, wherein the at least one processor unit is tested using an assigned self-test unit.

14. The method as recited in claim 8, wherein the self-test unit outputs an error message via self-test unit output means to at least one of an external display unit and an error processing unit if a fault is recognized in the at least one processor unit by the assigned self-test unit.

15. The method as recited in claim 8, wherein at least two processor units exchange at least one of starting values, intermediate results, intermediate values, and final results via the connection means, and wherein the at least two processor units check the at least one of starting values, intermediate results, intermediate values, and final results for uniformity.

16. The method as recited in claim 15, wherein one of the at least two processor units outputs an error message via processor unit output means to at least one of an external display unit and an error processing unit if the processor unit detects a deviation between the final results and one of the intermediate results and intermediate values.

17. The method as recited in claim 8, wherein, if errors occur in the memory unit, an error message is output via error detection unit output means to at least one of an external display unit and an error processing unit.

18. The method as recited in claim 8, wherein, if errors occur in the memory unit, an error message is transmitted via the memory management unit to the at least one processor unit, and from the at least one processor unit the error message is subsequently output via the processor unit output means to at least one of an external display unit and an error processing unit.
